(19) United States
(12) Patent Application Publication
(10) Pub. No.: US 2021/0161742 A1
(43) Pub. Date: Jun. 3, 2021

(54) KNEE SUPPORT

(71) Applicant: UPNRIDE ROBOTICS LTD., YOKNEAM ILIT (IL)

(72) Inventors: OMRI WEISS, RAMAT YISHAI (IL); MIRI SHEINIGIT, NAZARETH ILIT (IL)

(21) Appl. No.: 17/047,958

(22) PCT Filed: Apr. 16, 2019
(86) PCT No.: PCT/IL2019/050432

§ 371 Date: Oct. 15, 2020

Related U.S. Application Data
(60) Provisional application No. 62/657,943, filed on Apr. 16, 2018.

(51) Int. Cl. A61G 5/14; A61G 5/12

(52) U.S. Cl. CPC A61G 5/14; A61G 5/128; A61G 2200/36; A61G 2200/34; A61G 5/127

(57) ABSTRACT

Knee support system is provided to be incorporated within mobility apparatus. The knee support system comprises at least two oppositely positioned knee supports configured to be connected to members of the mobility apparatus, wherein the knee supports have a disengaged position in which the knee supports are laterally rotated and an engaged position in which the knee supports are harnessing legs of a user. Each of the knee supports comprises a bar and a bracket, wherein relative movement is maintained between the bar and the bracket so as to allow the bracket to laterally move in respect of the bar.

### FIELD

The present disclosed subject matter relates to human mobility apparatus. More particularly, the present disclosed subject matter relates to accessories of wheeled mobility apparatus.

### BACKGROUND

People with physical disabilities that need to sit for long time on a wheelchair or other mobile apparatus have problem of support to their legs. There are bands and straps available to be tied around the knees area and the wheelchair adjacent bars. There are also available supports having pivot points that force the knees to be closer to one another. Gel inserts are also available to soften the contact surface between the knees and the supports.

However, available supports cannot provide full support to the legs in the knees area in mobile apparatii that allows movements of the legs of the user while sitting or standing (in the case of the chair having standing position) as well as movements of the user in transitions from sitting to standing positioned and vice versa.

### SUMMARY

It is one aspect of the present disclosure to provide knee support system that provides full support to the legs of a person using any type of mobility apparatus.

It is another aspect of the present disclosure to provide knee support to be used in more sophisticated mobility apparatus that allows additional movement of the user and his legs such as standing wheelchair that needs additional support to the user.

It is yet another aspect of the present disclosure to provide a mechanical system that allows movements of the legs and the knees and simultaneously, supports and stabilizes the knees.

It is therefore provided in accordance with a preferred embodiment of the present disclosure, a knee support system to be incorporated within mobility apparatus, the knee support system comprising:
at least two oppositely positioned knee supports configured to be connected to members of the mobility apparatus, wherein the knee supports have a disengaged position in which the knee supports are laterally rotated and an engaged position in which the knee supports are harnessing legs of a user;
each of the knee supports comprises a bar and a bracket, wherein relative movement is maintained between the bar and the bracket so as to allow the bracket to laterally move in respect of the bar.

In accordance with another embodiment, the knee support is connected to the member via a hinge.

In accordance with another embodiment, the hinge is positioned at an end of the bar.

In accordance with another embodiment, the bar is a rail-bar and the bracket is configures to slide along an x-axis of the rail-bar.

In accordance with another embodiment, the hinge is provided with a lock configures to lock the knee support in the disengaged position or the engaged position.

In accordance with another embodiment, the bracket has a curved form factor and is designed to match a curvature of human leg below the knee.

In accordance with another embodiment, the knee supports are connected to the members in a way that allows adjustment of a height of the knee supports relative to the legs.

In accordance with another embodiment, the bracket is connected to the bar through a carriage and wherein the carriage moves along the rail.

In accordance with another embodiment, the bracket is connected to the bar via a pin that allows a rotational movement of the bracket relative to the bar.

In accordance with another embodiment, the bracket is rotating about the pin in 360 degrees clockwise and 360 degrees counterclockwise.

In accordance with another embodiment, the knee support can be upwardly and downwardly tilted by a predetermined angle relative to a horizontal axis.

In accordance with another embodiment, said predetermined angle is at most 15 degrees.

In accordance with another embodiment, the carriage with the bracket is tilted relative to the rail.

In accordance with another embodiment, the mobility apparatus is selected from a group of mobility apparatii consisting of a wheelchair; a standing wheelchair; an “EasyStand” standing apparatus, any combination thereof, or the like.

In accordance with another embodiment, the bracket is softened by pads.

### BRIEF DESCRIPTION OF THE DRAWINGS

Some embodiments of the disclosed subject matter described, by way of example only, with reference to the accompanying drawings. With specific reference now to the drawings in detail, it is stressed that the particulars shown are by way of example and for purposes of illustrative discussion of the preferred embodiments of the present disclosed subject matter only and are presented in the cause of providing what is believed to be the most useful and readily understood description of the principles and conceptual aspects of the disclosed subject matter. In this regard, no attempt is made to show structural details of the disclosed subject matter in more detail than is necessary for a fundamental understanding of the disclosed subject matter, the description taken with the drawings making apparent to those skilled in the art how the several forms of the disclosed subject matter may be embodied in practice.

In the drawings:

FIG. 1 shows a knee support system integrated with mobility apparatus while supporting the kneed of a user, in accordance with some exemplary embodiments of the disclosed subject matter;

FIG. 2A shows a left knee support in engaged position, in accordance with some exemplary embodiments of the disclosed subject matter;

FIG. 2B shows a right knee support in engaged position, in accordance with some exemplary embodiments of the disclosed subject matter;

FIG. 2C shows a left knee support in disengaged position, in accordance with some exemplary embodiments of the disclosed subject matter;

FIG. 2D shows a right knee support in disengaged position, in accordance with some exemplary embodiments of the disclosed subject matter;

FIG. 3A shows a perspective view of one knee support of the knee support system, in accordance with some exemplary embodiments of the disclosed subject matter;

FIG. 3B shows perspective view of another one knee support of the knee support system, in accordance with some exemplary embodiments of the disclosed subject matter;

FIG. 4A shows perspective view of yet another one knee support of the knee support system, in accordance with some exemplary embodiments of the disclosed subject matter; and

FIG. 4B shows perspective view of yet another one knee support of the knee support system, in accordance with some exemplary embodiments of the disclosed subject matter.

### DETAILED DESCRIPTION

Before explaining at least one embodiment of the disclosed subject matter in detail, it is to be understood that the disclosed subject matter is not limited in its application to the details of construction and the arrangement of the components set forth in the following description or illustrated in the drawings. The disclosed subject matter is capable of other embodiments or of being practiced or carried out in various ways. Also, it is to be understood that the phraseology and terminology employed herein is for the purpose of description and should not be regarded as limiting. The drawings are generally not to scale. For clarity, non-essential elements were omitted from some of the drawings.

Unless otherwise defined, all technical and scientific terms used herein have the same meaning as commonly understood by one of ordinary skill in the art to which this disclosed subject matter belongs. Although methods and materials similar or equivalent to those described herein can be used in the practice or testing of the present disclosed subject matter, suitable methods and materials are described below. In case of conflict, the specification, including definitions, will control. In addition, the materials, methods, and examples are illustrative only and not intended to be limiting.

Knee support system is provided to be incorporated within mobility apparatus. The knee support system is configures to allow at least one degrees of freedom and therefore comprises at least two oppositely positioned knee supports configured to be connected to members of the mobility apparatus, wherein the knee supports have a disengaged position in which the knee supports are laterally rotated and an engaged position in which the knee supports are harnessing the legs of a user. Each of the knee supports comprises a bar and a bracket, wherein relative movement is maintained between the bar and the bracket so as to allow the bracket to laterally move in respect of the bar.

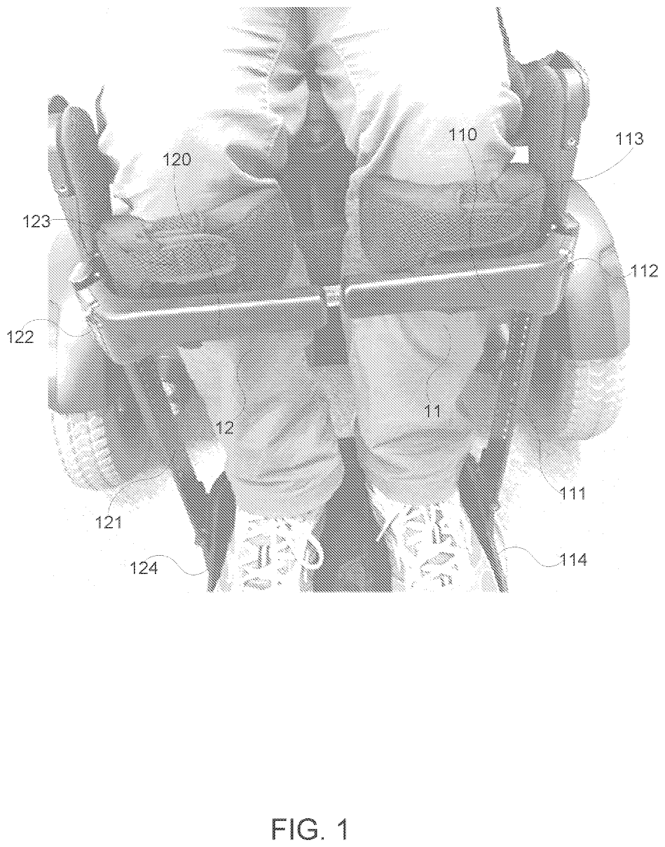

Referring now to FIG. 1 showing a knee support system integrated to mobility apparatus while supporting the kneed of a user, in accordance with some exemplary embodiments of the disclosed subject matter. The knee support system can be integrated with a manual or powered human mobility apparatus, such as a wheelchair; a standing wheelchair; an “EasyStand” standing apparatus, and any combination thereof, or the like.

In some exemplary embodiments of the disclosed subject matter, the knee support system may be comprised of at least two knee supports 110 and 120 mounted, opposite to one another, on members 111 and 121 respectively, wherein knee support 110 is adapted to harness the left leg 11 of a user to the mobility apparatus; and knee support 120 is adapted to harness the right leg 12 of the user to the mobility apparatus. In a preferred embodiment of the present disclosure knee support 110, i.e. left side, and knee support 120, i.e. right side, may be both based on similar design, however minoring one another. Thus, for the sake convenience, the description shall refer to both knee supports 110 and 120, as knee support. Yet it will be understood that the description hereinafter refers to both supports, unless specified otherwise.

In some exemplary embodiments, bottom ends of members 111 and 121 may be each connected to a foot base 114 and 124 respectively for each leg. Alternatively, foot bases 114 and 124 may be a single foot base, made of one piece, similarly connected to the members. In either alternative, the foot base(s) may be adapted to fit two feet and carry typical human weight while standing on the foot base. Additionally, or alternatively, the members 111 and 121 can be configured for adjusting the height of each knee support autonomously, so that padded brackets 113 and 123 can be positioned below the kneecaps.

The system of the present disclosure provides, mobility-apparatus, users having impaired standing and/or walking condition (but not limited to), with knee support for sitting or standing on the apparatus as well as changing position, e.g. from sitting to standing and vice versa. It should be noted that, standing on mobility-apparatus requires reliable knee supports for securing the user and prevent falling or sliding of the apparatus. One of the objectives of the present disclosure is providing users (sitting or standing) with support associated with small roll, pitch and lateral movements of each knee relative to the body-support system of the apparatus. Thereby, compensating for the movements without applying pressure on the knees.

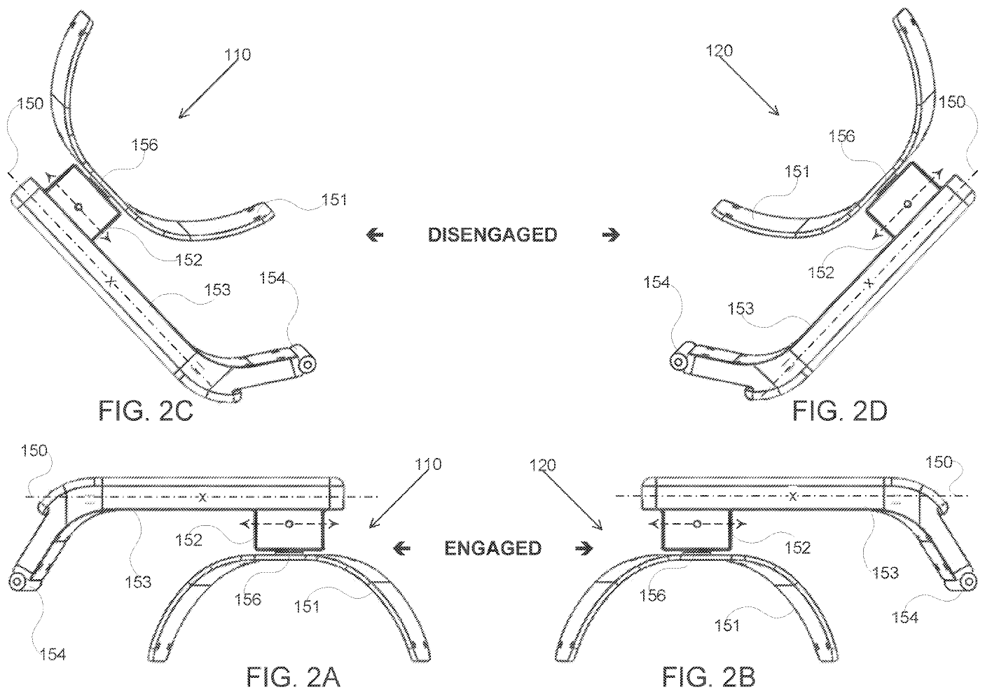

Referring now to FIGS. 2A and 2B showing the knee support system, i.e. left and right knee support, in engaged position and FIGS. 2C and 2D showing the knee support system in disengaged position in accordance with some exemplary embodiments of the disclosed subject matter. Both knee supports 110 and 120 may be autonomously engaged for harnessing the user's leg to the mobility-apparatus, alternatively, the knee supports can be disengaged, as shown in FIGS. 2C and 2D, to allow users to get on and off the mobility-apparatus.

In some exemplary embodiments, the knee support comprises a bracket 151 connected by pin 156 to carriage 152 that is configured to slide along x axis 150 of a rail-bar 153, which is terminated with hinge 154.

Generally, each of the knee supports comprises a bar and a bracket, wherein relative movement is maintained between the bar and the bracket so as to allow the bracket to move laterally in respect of the bar.

The hinge 154 can be used for connecting the knee support to the mobility-apparatus in a manner that facilitates rotating the knee support laterally to enable users to get on and off the mobility-apparatus. Equally, the hinge 154 can allow for the knee support to rotate inwards for securing the user's leg or legs in position, thus providing the user with knee support. In some exemplary embodiments, knee supports 110 and 120 may each comprise locks 112 and 122, (can be seen in FIG. 1) respectively, for locking the knee supports in engaged position. The locks 112 and 122 can be quickly released for getting off the mobility-apparatus.

In some exemplary embodiments, the bracket 151 having a curved form factor is designed to match the curvature of human leg below the knee. In addition, bracket 151 may be softened with pads designed to be dressed on brackets 151, as depicted by bracket pads 113 and 123, of FIG. 1. Carriage 152 connecting the bracket 151 to the rail-bar 153 can be configured to slide along the x-axis 150 of rail-bar 153 to allow for spreading the knees, away from each other, typically while sitting, and bring the knees closer to each other, typically while standing. The knee support of the present disclosure maintains knee support while smoothly adapts to the user's position and physical orientation, particularly when transitioning from sitting to standing and vice versa.

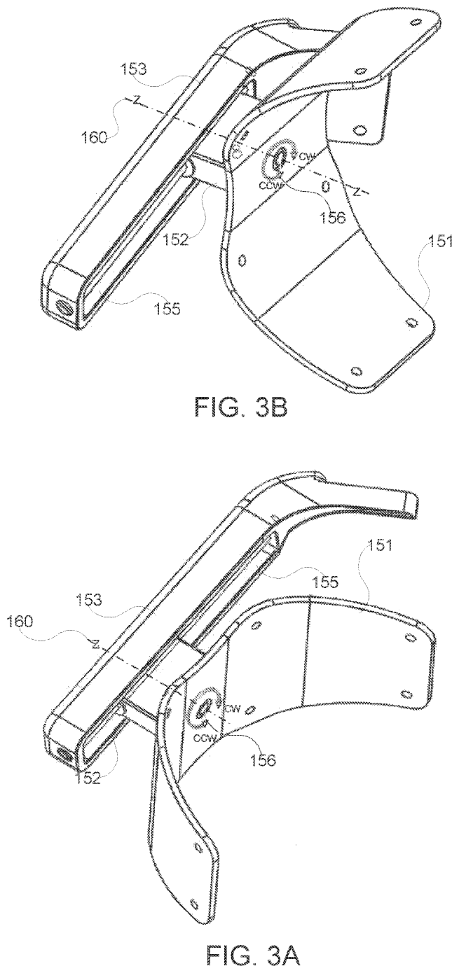

Referring now to FIGS. 3A and 3B showing perspective views of one knee support of the knee support system, in accordance with some exemplary embodiments of the disclosed subject matter. The rail-bar 153 comprises a rail mechanism 155 adapted to accommodate and interface with carriage 152 to provide for sliding of the carriage 152 within the rail-bar 153. In some exemplary embodiments, pin 156, connecting between the carriage 152 and the bracket 151, can be configured to allow for rotational (roll) movements around z-axis 160 (perpendicular to the x-axis 150) of the bracket 151. In some exemplary embodiments, the bracket can roll 360 degrees clockwise (CW) and 360 degrees counterclockwise (CCW). Thereby, the roll can further compensate for movements of the knees resulting from mobility-apparatus activities, such as shifting between sitting; standing; forward body-support; backward body-support; lateral body-support and any combination thereof.

It should be noted that any sliding mechanism can be employed without limiting the scope of the disclosed subject matter.

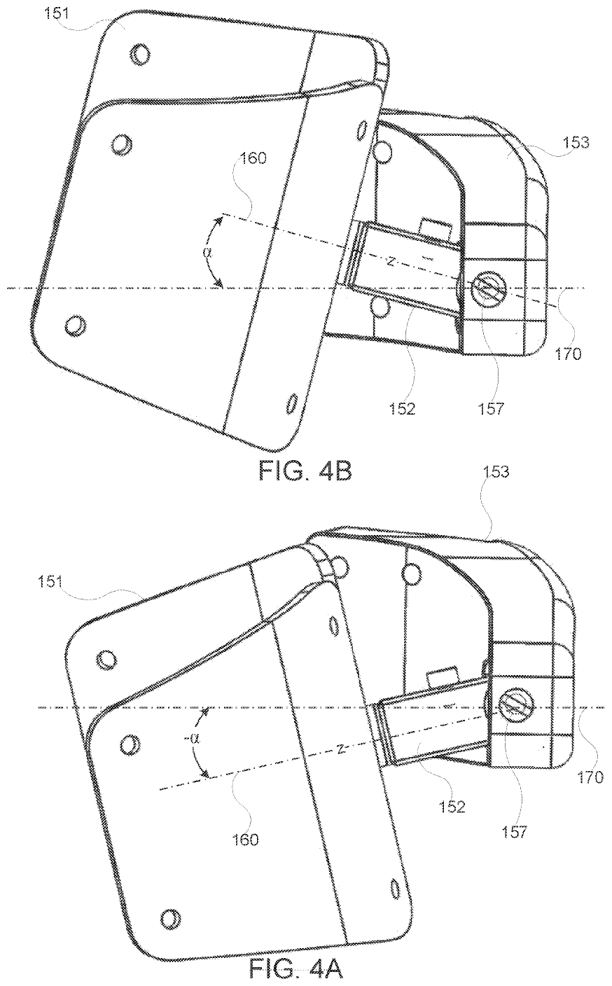

Referring now to FIGS. 4A and 4B showing perspective views of one knee support of the knee support system, in accordance with some exemplary embodiments of the disclosed subject matter. The knee support can be tilted as depicted in FIGS. 4A and 4B relative to a horizontal axis. In some exemplary embodiments, carriage 152 can be configured to tilt the bracket 151 by ±a degrees around a horizontal axis, wherein the horizontal axis is parallel to the ground, and wherein a may be at most 15 degrees. Appropriate stoppers are provided to stop the tilt in a predetermined angle. Independent tilting of each knee support further compensates for movements of the knees resulting from mobility-apparatus activities, such as shifting between sitting, standing; forward body-support backward body-support; lateral body-support and any combination thereof.

Therefore, a technical effect of utilizing the disclosed subject matter; which provides smooth sliding, rolling and tilting of the knee support; is preventing excess pressure on the knees of the user.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A knee support system to be incorporated within mobility apparatus for a user having limited control over his legs, the knee support system comprising:
at least two oppositely positioned knee supports configured to be connected to members of the mobility apparatus, wherein the knee supports have a disengaged position in which the knee supports are laterally rotated and an engaged position in which the knee supports are harnessing the legs of a user,
wherein each one of the knee supports comprises a bar and a bracket, wherein relative movement is maintained between the bar and the bracket so as to allow the bracket to laterally move with respect of the bar.

2. The knee support system of claim 1, wherein each one of the knee supports is connected to the member via a hinge.

3. The knee support system of claim 2, wherein the hinge is positioned at an end of the bar.

4. The knee support system of claim 1, wherein the bar is a rail-bar and the bracket is configured to slide along an x-axis of the rail-bar.

5. The knee support system of claim 2, wherein the hinge is provided with a lock configured to lock the knee support in the disengaged position or the engaged position.

6. The knee support system of claim 1, wherein the bracket has a curved form factor and is designed to match curvatures of a human's legs below the knee.

7. The knee support system of claim 1, wherein the knee supports are connected to the members in a way that allows adjustment of a height of the knee supports relative to the legs.

8. The knee support system of claim 1, wherein the bracket is connected to the bar through a carriage and wherein the carriage moves along the rail.

9. The knee support system of claim 8, wherein the bracket is connected to the bar via a pin that allows a rotational movement of the bracket relative to the bar.

10. The knee support system of claim 9, wherein the bracket is rotating about the pin in 360 degrees clockwise and 360 degrees counterclockwise.

11. The knee support system of claim 1, wherein the knee support can be upwardly and downwardly tilted by a predetermined angle relative to a horizontal axis.

12. The knee support system of claim 11, wherein said predetermined angle is at most 15 degrees.

13. The knee support system of claim 8, wherein the carriage with the bracket is tilted relative to the rail.

14. The knee support system of claim 1, wherein the mobility apparatus is selected from the group of mobility apparatuses consisting of a wheelchair; a standing wheelchair; an “EasyStand” standing apparatus; and any combination thereof.

15. The knee support system of claim 1, wherein the bracket further comprises softening pads.

16. The knee support system of claim 4, wherein the bracket is connected to the bar via a pin that allows a rotational movement of the bracket relative to the bar.

17. The knee support system of claim 6, wherein the bracket is connected to the bar via a pin that allows a rotational movement of the bracket relative to the bar.

18. The knee support system of claim 11, wherein the carriage with the bracket is tilted relative to the rail.

19. The knee support system of claim 6, wherein the bracket further comprises softening pads.
